(19) United States
(12) Patent Application Publication
(10) Pub. No.: US 2024/0056484 A1
(43) Pub. Date: Feb. 15, 2024

(54) METHOD FOR IMPUTATION OF CATEGORICAL DATA INTO MULTIPLE TIME SERIES OF CYBERSECURITY EVENTS

(71) Applicants: Siemens Aktiengesellschaft, Munich (DE); Federal University of Rio de Janeiro, Rio de Janeiro (BR)

(72) Inventors: Leandro Pfleger de Aguiar, Leander, TX (US); Henning Janssen, Karlsruhe (DE); Daniel Sadoc Menasche, Rio de Janeiro (BR); Lucas Miranda, Taquara (BR); Mateus Nogueira, Flamengo (BR); Daniel Vieira, Campo Grande (BR); Miguel Angelo Santos Bicudo, Aldeia da Prata (BR); Anton Kocheturov, Langhorne, PA (US)

(21) Appl. No.: 17/819,655

(22) Filed: Aug. 15, 2022

(51) Int. Cl. H04L 9/40

(52) U.S. Cl. CPC H04L 63/20; H04L 63/108; H04L 63/1433; H04L 63/1416

(57) ABSTRACT

A method for imputing data to a time series of events include collecting data relating to a plurality of events, storing the collected data in a database, defining a set of rules based on patterns observed, defining a new data relating to one of the plurality of events based on the set of rules. Defining additional rules and new data is iteratively performed based on new data and rules established in a prior iteration. The iterations may be stopped when no new rules or data is established in a previous iteration. The new data may be sequential temporal information of the event in the time series or may be a tag relating to the class of the event. The new data may be generated using rule mining. The new data is propagated to the rule mining and additional rules are defined based on the new data.

### TECHNICAL FIELD

This application relates to cybersecurity of industrial systems.

### BACKGROUND

Unpatched published vulnerabilities represent one of the most likely attack vectors for Industrial Control Systems. There are many reasons why patching industrial control system components is typically not performed immediately after the patch disclosure or vulnerability disclosure. Generally, fixes incorporated into the patches must be exhaustively tested both by the vendor and the asset owner prior to patching to avoid shut-down costs when an improper fix to control systems occurs. In addition, some patches require a complete system reboot, which may have to be synchronized with plant maintenance schedules to prevent additional outages besides a production outage that is already expected. Given the need to greatly limit downtime in industrial manufacturing, it is crucial to understand which components and vulnerabilities deserve the most attention and to assess the risk associated with cases where patches are not applied immediately. Prioritization of patching is also important for government agencies responsible for managing risks of massive, targeted attacks against the country's critical infrastructure. Possessing information about industrial control components that are more prone to attack help guide the use of limited resources and expertise.

This application builds on US patent application publication US 2018/0136921 entitled, Patch Management for Industrial Control Systems methods, systems, and computer-based systems for patch management of an industrial control system were described. A system to allow the prediction of the temporal evolution of risk due to vulnerabilities in order to help prioritize and schedule patching is described. A Markov chain representing temporal evolution is proposed utilizing asset (e.g., industrial control system component) specific information to determine risk over time. Then using this risk information patch scheduling is prioritized and/or scheduled. This allows operators to be armed with more relevant information to assist in managing patching of the industrial control system. Further, this allows better assessment of factors to be taken into account while applying patches, such as security risks and risks related to system unavailability, to determine when and if a patch should be immediately applied or deferred.

In European patent application publication number EP3975080A1 entitled, Automated Risk Driven Patch Management, methods, systems and algorithms are described for modeling, predicting and visualizing risks associated with security vulnerabilities. Methods presented leverage a time series of events to produce statistical models, which in turn provide insight for predicting how risks evolve over time. The more complete and more consistent the time series fed into the models are, the more useful the results will be. However, time series involving security vulnerabilities or exploitations are by their nature incomplete. This presents a challenge when using time-series data to predict risk as the data used as input may not reflect the whole picture. Improvements and methods for imputing the missing data in time-series data for predicting security risks is therefore desirable.

### SUMMARY

Embodiments described in this written description include a method for imputing data to a time series of events including the steps of collecting data relating to a plurality of events in the time series of events, storing the collected data in a database, defining a set of rules based on patterns observed in the collected data, defining a new data relating to one of the plurality of events based on the set of rules, and storing the new piece of data in the database.

According to an embodiment, rules are automatically derived from a dataset to characterize the available data, and the rules are iteratively applied to fill up missing data. The iterations of defining new rules and new data may be stopped on a condition that no new rules and no new data was established in a previous iteration. In some embodiments, the new data is sequential temporal information of the event in the time series in some embodiments the new data includes a tag relating to the class of the event. The new data may be generated using rule mining. In some embodiments the new data is propagated to the rule mining and additional rules are defined based on the new data. In certain embodiments the rule mining uses the popular Apriori algorithm developed by Agrawal and Srikant, “Fast algorithms for mining association rules”, Proc. 20^{th} int'l conference, very large databases, VLDB, Vol. 1215, pp. 487-499 (1994).

Each time series of events relates to a single cybersecurity vulnerability (CVE). Each CVE, in turn, relates to a base risk score (base CVSS) and its temporal extension (temporal CVSS). In some embodiments, system down time may be scheduled for an industrial system for installation of patch based on risk assessment of the cybersecurity vulnerability, e.g., as measured through the temporal CVSS.”

Other embodiments of this written description describe a system for imputing data to a time series of events. The system comprises a computer processor and a non-transitory computer memory, connected to the Internet, containing instructions that when executed by the computer processor, cause the computer processor to perform the steps of 1) collecting data, e.g., from the Internet, relating to a plurality of events in the time series of events, 2) storing the collected data in a database, 3) defining a set of rules based on patterns observed in the collected data, 4) defining a new data relating to one of the plurality of events based on the set of rules; and 4) storing the new piece of data in the database.

According to an embodiment defining additional rules and new data is iteratively performed in the computer processor based on new data and new rules established in a prior iteration. The iterations of defining new rules and new data may be stopped on a condition that no new rules and no new data was established in a previous iteration. In some embodiments, the new data is sequential temporal information of the event in the time series in some embodiments the new data includes a tag relating to the class of the event. The new data may be generated using rule mining. In some embodiments the new data is propagated to the rule mining and additional rules are defined based on the new data. In certain embodiments the rule mining uses the Apriori algorithm.

The time series of events relates to a single cybersecurity vulnerability. In some embodiments down time may be scheduled for an industrial system for installation of patch based on risk assessment of the cybersecurity vulnerability.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an architecture for imputation of events relating to a cybersecurity event timeline according to aspects of embodiments of the current disclosure.

FIG. 2 is a diagram illustrating training of a machine learning model to impute information into a cybersecurity event timeline according to aspects of embodiments of this disclosure.

FIG. 3 is a diagram illustrating training of a machine learning model to impute information into a cybersecurity event and predict a risk relating to the cybersecurity event timeline according to aspects of embodiments of this disclosure.

FIG. 4 is a graphical depiction of the increase in identified cybersecurity tags by imputing event data into cybersecurity event timelines according to aspects of embodiments of this disclosure.

FIG. 5 is a process flow diagram for imputation of information relating to cybersecurity events according to aspects of embodiments of this disclosure.

FIG. 6 is a block diagram of a computer system for performing imputation of information relating to cybersecurity events according to aspects of embodiments of this disclosure.

FIG. 7 is a block diagram of a computer system, which may be used for imputation of events relating to a cybersecurity event timeline according to aspects of embodiments of this disclosure.

### DETAILED DESCRIPTION

One of the most fundamental challenges involved in the use of multiple time series associated with cybersecurity events is found in their intrinsic incompleteness. By its nature, any cybersecurity dataset is incomplete. This is due to the cybersecurity ecosystem constantly evolving. Accordingly, there is an inherent incompleteness in the relevant data sources. For example, exploits typically do not explicitly refer to the identifiers relating to the vulnerabilities that they leverage. Additionally, the dates at which advisories are posted at the National Vulnerability Database (NVD) are not readily available and further complicating the situation is that tags relating to the nature of changes for source code available at GitHub are frequently only partially filled.

Described herein is a novel approach for imputing categorical data into multiple time series of events associated with cybersecurity events. First, methods for imputation of a sequence of a cybersecurity event in a time series of events relating to the same vulnerability is provided. Given a series of events associated with a vulnerability, when a new advisory is discovered, its position in the sequence of already existing events needs to be determined. One alternative is to manually determine the date at which the advisory was released and position the advisory in its chronological position in the time series of events. According to described embodiments herein, an improved automated approach for the imputation of categorical data is presented. For instance, to determine the position of a security advisory without manually inspecting the contents of the advisory. To this end the historical temporal patterns of security advisory releases are leveraged using techniques including automatic rule mining.

Second, security advisories may be received without tags, which help classify the advisory. Methods are provided that impute tags to cybersecurity advisories to provide a richer dataset that may be obtained through conventional means. Given a series of events associated with a vulnerability, some of those events may be tagged according to their types, (e.g., patching, weaponization or vendor advisory). In some cases, events may appear without tags. Some of the techniques used for imputation of security advisory platforms above may further prove useful for the imputation of associated tags to untagged events. The use of automatic rule mining may be used in embodiments for the purpose of tag propagation, leveraging at least two data sources (e.g., National Vulnerability Database (NVD) and GitHub) both of which provide tags for their events.

As discussed, both security advisory platform and security advisory tag imputation may be performed using automatic rule mining. In the embodiments described in this disclosure rule mining may be performed using the Apriori algorithm, however it will be recognized that other rule mining techniques may be used. Methods for imputation of platforms and tags according to aspects of embodiments of this disclosure may comprise the following steps:

Data collection: Data may be collected from security advisories that are publicly published, (e.g., the NVD). For each vulnerability, NVD reports its common vulnerability & exposures (CVE) id together with a list of hyperlinks to security advisories on other platforms. The content of the resource indicated by those hyperlinks may be downloaded, and the corresponding HTML files processed, along with some data provided by NVD report itself. The available data is processed and curated to produce a training set for identifying rules based on patterns in the data. Using the collected data (e.g., hyper-text markup language (HTML) files, javascript object notation (JSON) files, dates and tags (classes)) for the advisories are obtained. Some examples of tags may include weaponization, remediation or advisory among other tags. Some of this information is available publicly from sources such as NVD. To identify the dates when each advisory was published, the specifics of the format of the HTML files provided by each platform may be examined. For instance, XPath, the XML Path Language, may be used to extract temporal information from the HTML files. Each platform corresponds to a given XPath parametrization for extraction of the HTML element corresponding to the publication dates of the advisories posted by that platform. After implementing such a process, for each security advisory its (i) publication date, (ii) NVD hyperlink, (iii) list of CVEs at NVD that contain that hyperlink, and (iv) class of the hyperlink may be obtained. The elements may be stored in a database.

The structured data obtained is used to perform modeling and may be utilized in machine learning to define rules relating to patterns in the data. The temporal information about events associated with all vulnerabilities reported at NVD is collected. The result is a dataset of time series encompassing vulnerabilities along with the dates of release of corresponding exploits, patches, and advisories, which are representative of typical events in the vulnerability life cycle. Using those time series, patterns from the data may be learned. For example, the ordering of security advisory platforms appearing in the time series, and how tags relate to each other may be learned from the data.

A performance assessment of described embodiments was performed to test the proposed solution using a test set containing security advisories with known publish dates and/or tags and assessing the accuracy of the predictions provided by the proposed solutions. When the accuracy is found to be unsatisfactory, additional tuning of parameters may be considered. Data obtained from security advisory temporal positions and tags may be augmented with additional data imputed using the proposed methods.

Embodiments of this disclosure extend and improve the techniques previously described in US published applications US2018/0136921A1—Patch Management for Industrial Control Systems and European patent application publication number EP3975080A1 entitled, Automated Risk Driven Patch Management. Prior art proposed heuristics to automatically parametrize risk scores (e.g., CVSS scores) from data, using multiple time series. However, those works did not present methods and tools to sanitize and insert missing data into those time series. In particular, previous methods did not consider the problem of imputation of categorical data into multiple time series of events. In addition, prior work did not consider the imputation of platform and tag data into multiple time series of cybersecurity events for the purpose of eventually predicting CVSS temporal scores for decision making.

The following paragraphs describe the state of the art for topics related to cybersecurity and vulnerability management including vulnerability lifecycle, prediction of occurrence of exploits and commercial applications.

Vulnerability lifecycle: large-scale empirical and systematic analysis of security vulnerabilities have been conducted by Frei et al, and Shahzad et al. In these previous works, the authors study the availability of exploits and patches to model risk exposure and support business decisions. However, they did not consider the problem of sanitizing and cleaning the time series of events associated with each of the different considered vulnerabilities, which are key factors in the study of vulnerability lifecycles.

Prediction of occurrence of exploits: Data mining and machine learning tools have been used to predict the occurrence of exploits. Nonetheless, previous work has not accounted for methods and tools to clean multiple time series used during the training process to generate those predictions. In embodiments of this disclosure, novel methods to integrate novel data, e.g., from new security advisory events into existing time series are achieved. In addition, methods to impute tags to events leveraging data from diverse sources (e.g., NVD and GitHub) are provided.

Commercial applications: Commercial vulnerability scanning and management applications such as Tenable Nessus, Tenable Industrial, or Qualis, present the CVSS together with a qualitative measure of the criticality of any given vulnerability identified. None of those tools, however, clearly explain to users the relationship between information regarding potentially existing exploits, vulnerability weaponization and other events in the life cycle of vulnerabilities and the displayed risks. The embodiments described in this disclosure focus on the production of cleaned and sanitized time series of events associated with vulnerabilities, which may be enriched and augmented in an online fashion using the proposed methods and tools.

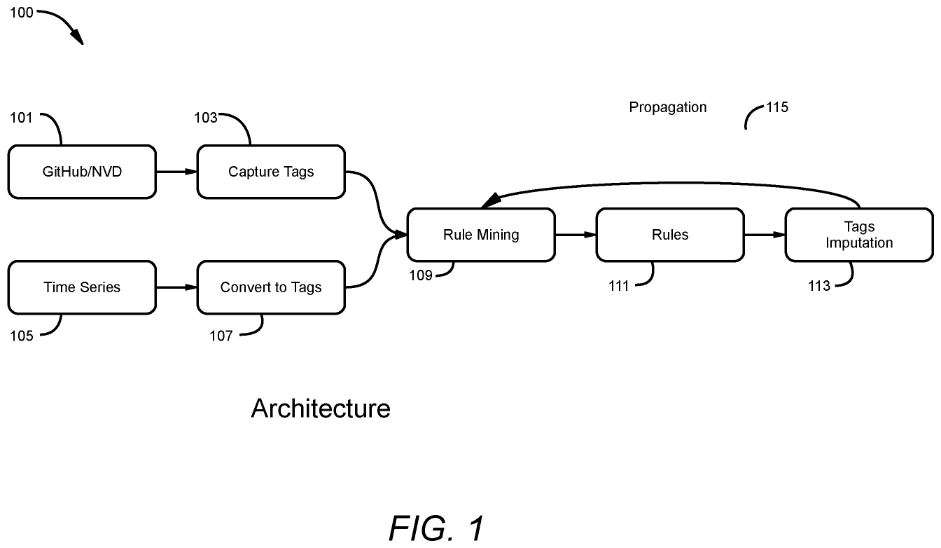

FIG. 1 provides an overview for the generation of a model for assessing risk relating to a cybersecurity advisory. Initially, two sources of data are considered. First, advisories may be found at public repositories such as GitHub or NVD 101, which includes tags to classify each event. Other information relating to a cybersecurity event may be found that do not include tags for classifying the information. The context of the untagged event, such as the position of the event in a time series of related events 105, may be enhanced by inferring tags for the event and adding the imputed tags to the event 107. When tags have been collected or generated, they are presented to the rule mining function 109 to identify patterns in the collected data. From the rule mining function 109, rules relating to the various events are identified 111. Using the rules, additional tags may be imputed to the data 113 to make the data more robust. As new rules and new tags are imputed, additional patterns may emerge. For this reason, the newly generated information is propagated 115 back the rule mining function 109. The process of rule mining 109, discovering new rules 111, imputing new tags 113 and propagating the new data 115 may be repeated until a convergence occurs. A convergence may be identified when no new rules are generated, and/or no new tags are imputed. Once convergence occurs, the information may be used to model and predict risk for a given cybersecurity vulnerability.

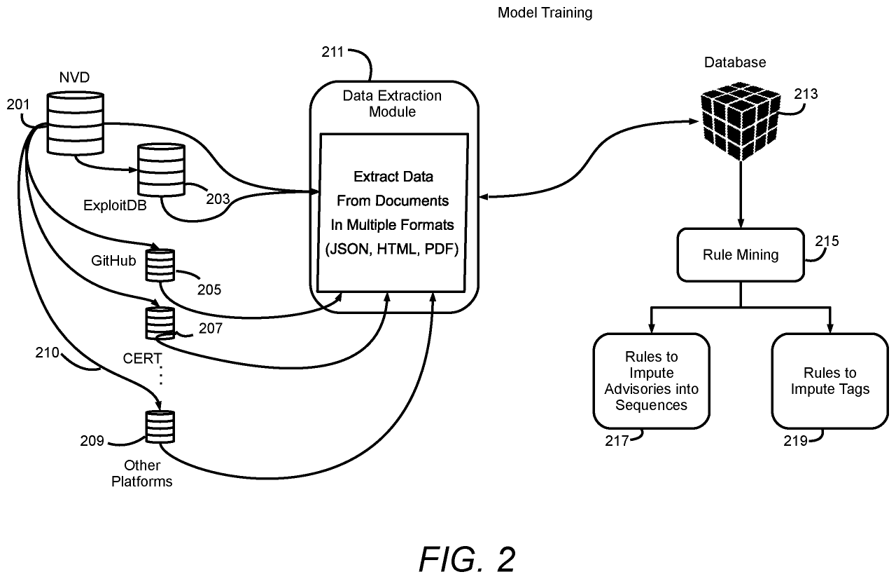

FIG. 2 is a diagram illustrating the training of a model for imputing data in time-series of cybersecurity events according to aspects of embodiments of this disclosure. Information relating to cybersecurity events may be accessed from a public source such as NVD 201. The information includes tags relating to the cybersecurity event and provides hyper-links 210 that provide a uniform resource identifier (URI) or uniform resource locator (URL) for further information on other cybersecurity platforms relating to the cybersecurity event. A data extraction module 211 processes the web pages and resources identified in the hyper-links 210 to extract information relating to the characteristics of the associated cybersecurity information. For example, the format of the page indicated by the URI may include information that may be used to determine the date that the web page indicated by the URI was created. This information may be used to properly insert the information into a time-series of events relating to the cybersecurity event. The collected information obtained through the hyper-links 210 is stored in a database 213. The information in the database 213 is processed to perform rule mining on the patterns and sequences of the data in database 213. According to some embodiments, the Apriori algorithm for rule mining may be used. Other techniques may also be used. The data in database 213 is analyzed using rule mining, which provides rules for sorting advisories into time sequences 217. Additionally, the data provides information for making rules related to the imputation of tags related to events or advisories that were received originally without tags.

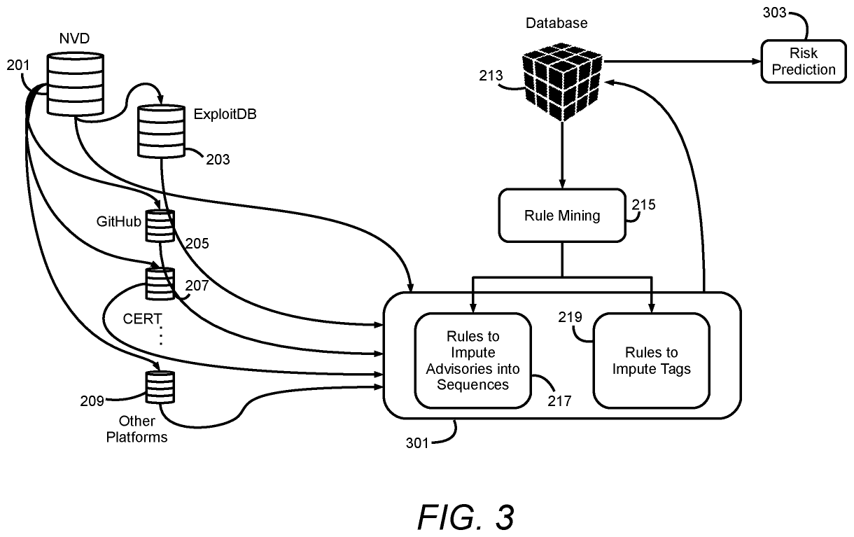

FIG. 3 provides a diagram of rule-based inference and risk prediction architecture according to aspects of embodiments of this disclosure. Given a new security advisory, the proposed method positions the advisory in its corresponding position within a temporal series. In addition, it may also infer tags associated with a class of the advisory. With an updated database of multiple time series of security events, new and more accurate risk predictions are produced.

A new security advisory may be received from NVD 201. The advisory may include information and links to other repositories, such as ExploitDB 203, GitHub 205, CERT 207 or other platforms 209. The information contained in the sites referenced by links 210 may provide additional tags related to the event. In other cases, the data may be untagged. The information is provided to the rules processor 301 which uses determined rules in an attempt to put the security advisory in its proper sequence within a time series of events relating the cybersecurity vulnerability 217. In cases where the new security advisory is untagged, rules may be used to impute tags to the new security advisory to better represent the nature of the advisory.

An application of the proposed methods is to impute common tags into events. In particular, typical platforms such as the National Vulnerability Database (NVD) and GitHub frequently already contain tags for many of the reported events. By combining tags from multiple platforms, a richer dataset may be produced. Subsequently applying rule mining and tag imputation, cross-related tags from various sources and data patterns behind the dynamics of the related tags are learned reflective of their corresponding events.

NVD already tags several of the references appearing at GitHub, e.g., as patch or exploit. However, there are still many repositories at GitHub that are not referred to by NVD. Those repositories are tagged by GitHub, but not by NVD. By combining data from NVD and GitHub, the few tags marked by NVD can be propagated through all of the GitHub repositories, identifying across all repositories those that correspond to patches and those that correspond to exploits.

Below is a list of some of the tags associated with webpages of repositories. NVD currently supports 17 tags. GitHub, in turn, naturally yields a number of natural tags including: 1) file extensions; 2) labels; 3) URL type (already set by GitHub) and 4) keywords in GitHub pages (selected based on expert knowledge or on objective criteria such as the mutual information between the words and the classes of interest, such as patch or exploit).

| | GitHub | GitHub | GitHub | Keywords |
|---|---|---|---|---|
| | File | Issues | URL | in GitHub |
| NVD | Extension | Labels | Type | Pages |
| (17 tags) | (38 tags) | (8 tags) | (4 tags) | (14 tags) |
| third_party_advisory | .MD | cve | commit | fix |
| broken_link | .TXT | vulnerability | issues | cve |
| patch | .adoc | critical | pull | reproduce |
| exploit | .bt | exploit | other | payload |
| issue_tracking | .c | bug | | steps |
| mitigation | .cpp | security | | poc |
| . . . | . . . | . . . | | . . . |

Referring to FIG. 1, the first step in the pipeline is to capture the largest number of tags to apply a Rule Mining algorithm. In addition to the natural tags already provided by NVD, and information about the HTMLs referred at the NVD website, this information may be supplemented considering tags provided by GitHub and other platforms, either explicitly or implicitly. After capturing all tags, a Rule Mining algorithm is executed, such as the Apriori algorithm. Below is an example of an rule obtained through the rule mining process:
(poc_word, md_url_file_ext, third_party_advisory_nvd_tag)→(exploit_nvd_tag)

This rule, based on a sample dataset is found to have a confidence of 93% and indicates that a vulnerability which contains 1) the keyword ‘poc’ (proof-of-concept), 2) file extension ‘.md’ and 3) NVD tag ‘third_party_advisory’ should also receive the tag ‘exploit_nvd_tag’. That is, it should be treated as an exploit.

Once a set of rules is obtained, the generated rules may be propagated back to rule mining, e.g., up until reaching a fixed point wherein further applying the rules does not produce any new tag. While doing so a criterion may be set to determine which rules should be applied based on factors such as the rule's confidence measure. A threshold of 70% for confidence, meaning that rules with a confidence greater than 70% should be applied, was observed to perform well, although other confidence levels or thresholds may be considered.

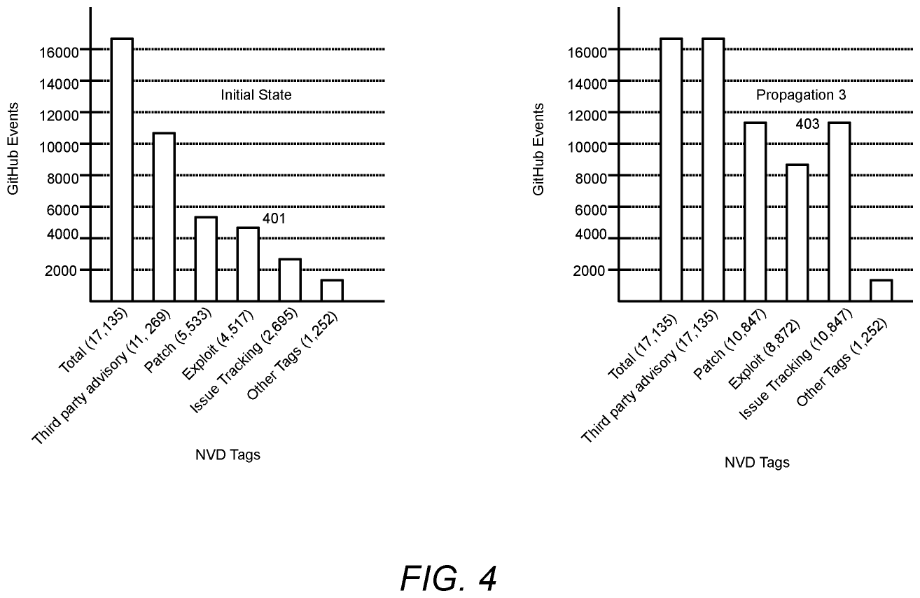

FIG. 4 is a graphical depiction of a number of tags associated with cybersecurity events at their initial stage versus the number of tags for the same set of events after three iterations of rule mining, propagation, and applying the generated rules according to embodiments described herein. FIG. 4 indicates that after three iterations of rule propagation as shown in FIG. 1, the number of advisories marked with a ‘patch’ tag grows from 5,533 to 10,847, while the number of ‘exploits’ tags grows from 4,517 to 8,872. Clearly, the imputation of tags to the data set provides a richer set of data better suited for assessing risks associated with the tagged events.

The proposed approach according to embodiments of this disclosure may be used for advisory data that does not originally contain explicit tags. For illustrative purposes, consider the problem of imputation of security advisories (categorical data) into multiple time series of security events. In that case, given a new advisory, the goal is to determine its position in an already ordered list of existing security advisories associated with a given vulnerability. For each vulnerability, each platform issuing an advisory, together with its position in the time series associated to that given vulnerability, may together correspond to a tag formed by an ordered pair (platform, ordinal position in the series of events). Time series are represented by sequences of ordered pairs. If initially there are 12 platforms of interest, each platform appearing in the sequence may be represented by a tag of ordered pair (platform, index), where index is an integer number ranging from 1 to 12, assuming that each platform publishes at most one advisory for each vulnerability.

Consider the following sequence:
NVD, SECURITY_FOCUS, <PROVIDER>

This time series would translate into tags containing order pairs (NVD, 1), (SECURITY_FOCUS, 2) and (<PROVIDER>, 3). Subsequently, Rule Mining is applied to extract rules leveraging the provided ordered pairs. Data may then be imputed to the data based on the obtained rules. If a new advisory is discovered, e.g., from a third party repository, the dataset of rules is searched for a rule that matches (NVD, 1), (SECURITY_FOCUS, 2) and (<PROVIDER>, 3) in its antecedent (left hand side of a rule) and that contains (third-party, i) in its consequent (right hand side). Index i is used to determine the position of the third party in that sequence. In case of ties, additional criteria may be used to break ties. In the above example, if there is a more specific rule leveraging the three elements in the antecedent, and another more general rule, (e.g., leveraging only (NVD, 1)) in its antecedent, the former more detailed rule should generally be preferred.

if all dates of all advisories are known in advance, any advisory can be immediately inserted in its right position in the time series. However, it is usually the case that dates are not available, and one needs to infer those before a manual inspection of the material reveals the correct release date. The above illustrative example serves as a use case of the method. In general, the method can be used to impute categorical data into multiple time series, using Rule Mining.

The methods for imputing data to cybersecurity events described herein provide improvements to systems for assessing risk associated with the implementation of patches and fixes in response to cybersecurity vulnerabilities. Embodiments herein described provide many benefits, including but not limited to, explainable imputation, improved insight into tradeoffs between risk of deferring patches versus vulnerability, is extendable as new information relating to vulnerabilities is available, and eliminates the need for manual tagging.

The rules used to impute data into the multiple time series can be easily parsed by humans, allowing them to explain and interpret why certain advisories were inserted at given points in their corresponding time series, or why certain tags were added to certain advisories.

Given the new time series, the plant operator is able to trade off the risk of patch deferral with the vulnerability exploitation risk, and to predict the potential risks based on what-if analysis.

Additional data about the vulnerabilities may be updated as it is collected with the data being inserted into a database even in the absence of some of its features. The absent features can be imputed using pre-established rules. In particular, to add an advisory into a time series of events the position at which the advisory must be inserted must be known. The method proposed in this disclosure allows for insertion of the advisory into its time series without parsing its contents. Manually tagging events is a costly and time-consuming task. The rule-based automated methods proposed in this invention allow to efficiently tag and classify cybersecurity events leveraging information collected from multiple sources.

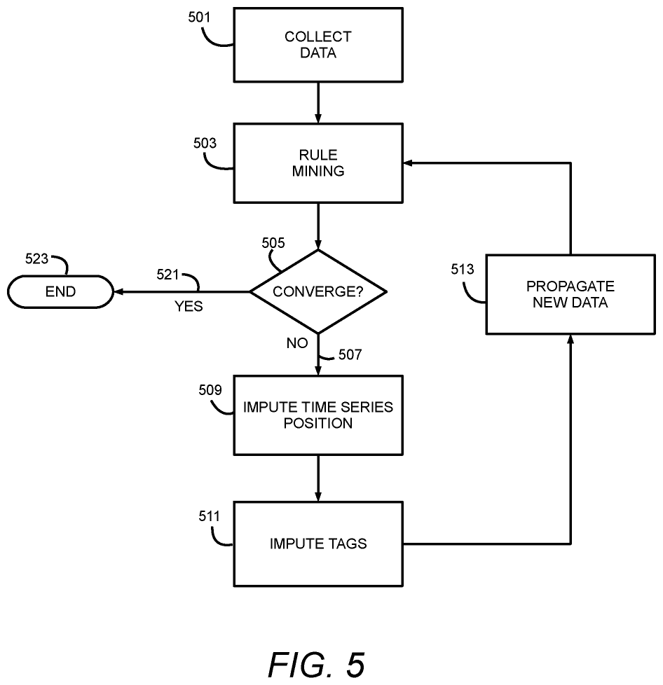

FIG. 5 is a process flow diagram for training a system for assessing the risk associated with a cybersecurity vulnerability, according to aspects of embodiments described in this disclosure. First, data is collected 501. Data relating to cybersecurity events may be found on publicly available repositories including NVD. The entry in NVD may include hyperlinks to other sources containing information about the cybersecurity vulnerability. By inspecting the contents of information stored at the location in the hyperlink, additional information about the cybersecurity event may be obtained. Analyzing the information and the characteristics of the target site, additional information about the information may be determined. For example, by examining the html format of the file at the hyperlink location, a date that the information was posted may be determined. This information may allow the entry to be placed in chronological order with other events associated with a cybersecurity vulnerability.

When data is collected, rule mining 503 may examine the data to identify patterns and relationships between data elements in the data store. Based on observed patterns, rule mining defines rules for characterizing cybersecurity events. Characteristics may include position of the event within a time series of events relating to a vulnerability. In other cases, the rule mining may identify characteristics relating the placement of an event Based on the available data, the rule mining process 503 eventually determines that the rule mining converged 505. If convergence has occurred, there are no new rules being applied or created. At this time, the process may end 523 and the rule repository is fully trained. As the rule mining process 503 proceeds, rules may provide for imputation of an event in proper sequence in a time series of events 509. Rule mining 503 may further generate rules for imputing tags to events which are received without original tags 511. When rule mining results in new data from imputing time series sequences 509 and/or imputing new tags 511, the data set acquires new information which may contribute for further rule mining 503. The newly imputed data may be propagated 513 back to the rule mining process 503. The new data may be reprocessed by rule mining process 503 if no new rules are established, convergence 505 occurs 521 and the process ends 523. Otherwise, the rule mining process 503 creates new rules and does not converge 507. The new rules are used to attempt imputing new sequences in time series 509 and new tags 511 to cybersecurity events.

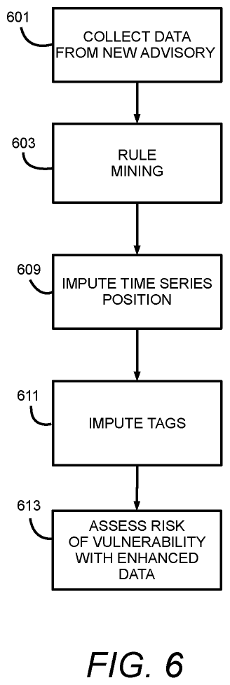

FIG. 6 provides a process flow diagram according to aspects of embodiments of this disclosure for processing a new cybersecurity advisory. A new advisory relating to a cybersecurity vulnerability is released. Data relating to the new advisory is collected 601. The advisory may include hyperlinks to other sources containing additional information related to the vulnerability. The collected data is stored in a database and evaluated by a rule mining process 603. The rule mining process 603 examines the collected data to recognize patterns and relationships between data elements. Rules are established based on the observed patterns. Using the rules, the collected data is updated. For example, the new advisory may belong in a sequence position in a time series of events relating to the same cybersecurity vulnerability. The advisory may be assigned to its proper sequence based on the data collected at step 601. The determined position in the time series of events is imputed to provide information that enhances the information existing before the rule was applied 609. Additionally, some data may be received without tags to identify the nature of the advisory. Using rule mining 603, rules may be established, which allow imputation of new tags to the advisory based on the existing data according to the established rule 611. By imputing events into their proper time series sequence 611 and imputing new tags to classify events 613, the data used to assess cybersecurity risk of a vulnerability is enhanced with data that did not exist in the originally captured information. Using the enhanced data, the risk of the vulnerability is assessed 613 to inform a stakeholder of the risk involved in not taking corrective action to address the vulnerability or to inform the stakeholder on a timeframe in which the corrective action should be taken.

In summary, the proposed method is instrumental to refine and document risk evolution for previous events associated with vulnerabilities and serves as an ingredient to predict how risk will evolve in the future, being more efficient than ad hoc solutions which cannot be explained or that lack rigor with respect to the rules used for the imputation of advisories and their tags.

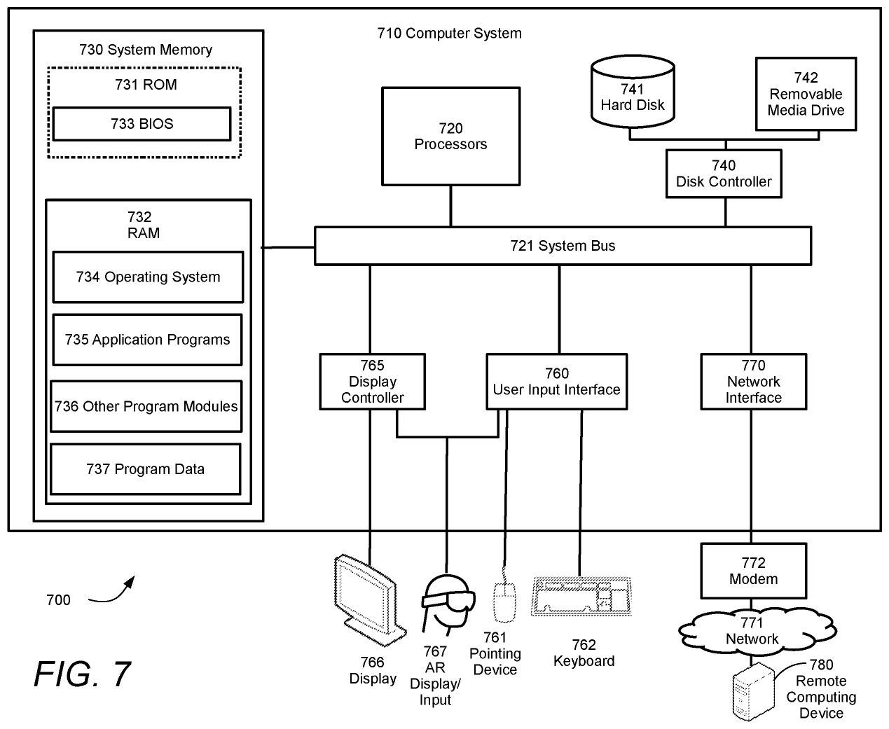

FIG. 7 illustrates an exemplary computing environment 700 within which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller, or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random-access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid-state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761. In some embodiments, an augmented reality device 767 that is wearable by a user, may provide input/output functionality allowing a user to interact with both a physical and virtual world. The augmented reality device 767 is in communication with the display controller 765 and the user input interface 760 allowing a user to interact with virtual items generated in the augmented reality device 767 by the display controller 765. The user may also provide gestures that are detected by the augmented reality device 767 and transmitted to the user input interface 760 as input signals.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 771.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A method for imputing data to a time series of events comprising:
collecting data relating to a plurality of events in the time series of events;
storing the collected data in a database;
define a set of rules based on patterns observed in the collected data;
defining a new data relating to one of the plurality of events based on the set of rules; and
storing the new piece of data in the database.

2. The method of claim 1, further comprising:
iteratively defining additional rules and new data relating to the plurality of events based on new data and new rules established in a prior iteration.

3. The method of claim 2, further comprising:
stopping the iterations of defining new rules and new data on a condition that no new rules and no new data was established in a previous iteration.

4. The method of claim 1, wherein the new data is sequential temporal information of the event in the time series.

5. The method of claim 1, wherein the new data comprising a tag relating to the class of the event.

6. The method of claim 1, further comprising:
defining the new data by using rule mining.

7. The method of claim 6, further comprising:
propagating the new data back to the rule mining; and
defining additional rules based on the new data.

8. The method of claim 6, wherein using the rule mining comprises using an Apriori algorithm.

9. The method of claim 1, wherein time series of events relate to a single cybersecurity vulnerability.

10. The method of claim 1, further comprising:
re-ordering a sequence of security events to chronological order in a timeline.

11. A system for imputing data to a time series of events comprising:
a computer processor;
a non-transitory computer memory in communication with the computer processor, the computer memory containing instructions that when executed by the computer processor, cause the computer processor to perform the steps of:
collecting data relating to a plurality of events in the time series of events;
storing the collected data in a database;
define a set of rules based on patterns observed in the collected data;
defining a new data relating to one of the plurality of events based on the set of rules; and
storing the new piece of data in the database.

12. The system of claim 11, the computer memory further comprising instructions that when executed by the computer processor cause the computer processor to:
iteratively define additional rules and new data relating to the plurality of events based on new data and new rules established in a prior iteration.

13. The system of claim 12, the computer memory further comprising instructions that when executed by the computer processor cause the computer processor to:
stop the iterations of defining new rules and new data on a condition that no new rules and no new data was established in a previous iteration.

14. The system of claim 11, wherein the new data is sequential temporal information of the event in the time series.

15. The system of claim 11, wherein the new data comprising a tag relating to the class of the event.

16. The system of claim 11, the computer memory further comprising instructions that when executed by the computer processor cause the computer processor to:
define the new data by using rule mining.

17. The system of claim 16, the computer memory further comprising instructions that when executed by the computer processor cause the computer processor to:
propagate the new data back to the rule mining; and
define additional rules based on the new data.

18. The system of claim 16, wherein using the rule mining comprises using an Apriori algorithm.

19. The system of claim 11, wherein time series of events relate to a single cybersecurity vulnerability.

20. The system of claim 11 the computer memory further comprising instructions that when executed by the computer processor cause the computer processor to:
schedule down time for an industrial system for installation of patch based on risk assessment.
